(19) United States
(12) Patent Application Publication
(10) Pub. No.: US 2004/0073681 A1
(43) Pub. Date: Apr. 15, 2004

(54) Method for paralled data transmission from computer in a network and backup system therefor

(76) Inventor: Flemming Danhild Fald, Vejle (DK)

Correspondence Address: CANTOR COLBURN, LLP, 55 GRIFFIN ROAD SOUTH, BLOOMFIELD, CT, 06002

(21) Appl. No.: 10/399,931

(22) PCT Filed: Oct. 25, 2001
(86) PCT No.: PCT/DK01/00707

(30) Foreign Application Priority Data
Oct. 25, 2000 (DK) BA 2000-00042
Mar. 20, 2001 (DK) BA 2001-00085

(51) Int. Cl. G06F 15/16; G06F 15/173

(52) U.S. Cl. 709/227; 709/223

(57) ABSTRACT

The invention relates to a method of parallel transmission of data files from computers in a computer packet network and storage of said data files in a backup system connected to said network. The method comprises the steps of establishing connections between at least two backup application agents of at least two computers and teh backup managing means of said bckup system, parallel transmission of data files from at least one computer with some form of identification from said at least one backup application agent to said backup managing means, and storage of said data files in one or more databases of said backup system. The invention also relates to a backup system and a computer program product.

### BACKGROUND OF THE INVENTION

The present invention relates to a method of parallel transmission of data files from computers in a computer network and storage of said data files in a backup system connected to said network, a backup system, a computer program product and use hereof.

The prior art backup systems for one or more computers in a computer network usually involve periodic storage of data on a storage media, such as backup tapes or special backup hard disks. The backup session is performed successively and follows a backup scheme indicating which data should be stored when and where. To ensure reasonable safety against loss of data, the backup is performed frequently e.g. daily.

Lately, backup systems allowing for a more reliable backup have been suggested. These systems store at such a high frequency that the amount of data lost may be limited to an absolute minimum. Further, backup systems which successively detect changes in computer files and store the changes have also been suggested.

However, known backup systems have a number of drawbacks including the risk of loosing data between two backup sessions. The systems also require a considerable amount of storage space and time in order to backup even small computer systems.

One of the objects of the invention is to create a backup system without the above-mentioned problems. In particular, it is an object of the invention to create a system that only stores the necessary data and performs the backup in a fast and efficient manner.

### THE INVENTION

In accordance with the invention, claim 1 states a method of parallel transmission of data files from computers in a computer network and storage of said data files in a backup system connected to said network, said method comprising the steps of establishing parallel data communicating connections between at least two backup application agents of at least two computers and the backup managing means of said backup system, parallel transmission allowing transmission of data files from at least one computer with identification codes from said at least one backup application agent to said backup managing means, and storage of said data files in one or more databases of said backup system.

By means of the parallel transmission of data files from the computers in the network, a faster backup may be performed. Especially, it is possible to perform continuous transmission of data files from the computer and thus enhance the safety of the computer system and avoid loss of data.

The term “computer” may be understood as any kind of data processing systems such as work stations and all kind of computer servers.

The term “identification codes” is to be understood as any kind of code that will allow the backup managing means to identify the individual backup application agents and data files from the agents. This is especially possible in a client/server management system.

The term “data files” is to be understood as any kind of data files including control system files, program files and document files.

The term “control system files” is to be understood as any kind of operating system files or other component files being able to manage the set-up of one or more computers (clients or servers) in the network.

The term “data communicating” is to be understood in this application as communication between the backup managing means and the backup application agents e.g. the backup managing means pinging (requesting a response) the agents and the agents responding to the ping or vice versa.

The terms involving “parallel” such as parallel communication, parallel transmission and multitasking in a parallel mode are to be understood as processes that may take place simultaneously in an independent manner e.g. parallel transmission on a computer network where data packets are transmitted without interfering by using different ports in the network. In an embodiment of the invention the backup server may give the ports to the computers in a randomised manner.

The transmission structure of the computer network may be copper lines, glass fibres or other well-known types of transmission used in connection with communication systems.

When, as stated in claim 2, said backup application agents continuously monitor the activity of the computers and transmit data files to said backup managing means, it is possible to create a backup system which allows fast and complete recovery of the individual computer files after a breakdown, e.g. a hard disk crash on a computer in a computer network. The recovery may take place as a network transfer of the necessary files to the computer, where the files may be transferred with the original file structure. The file structure of the computer is previously stored in connection with the backup sessions.

When, as stated in claim 3, said transmitted data files are transmitted as compressed data packets, it is possible to handle large amounts of data on a computer network without influencing the network response time significantly. The use of compressed data packets may increase the number of computers that can be connected to the backup system.

When, as stated in claim 4, said backup application agents continuously or discontinuously control the status of the backup managing means, it is possible improve the safety procedures in the computer system.

When, as stated in claim 5, said backup application agents report an offline status of the backup managing means to the users of the computers, e.g. by means of a pop-up message on the screens of the computers, the backup application agent may alert the user of the computer with which the agent is associated. The user may then report the server status to the network administrator.

When, as stated in claim 6, said backup managing means continuously or discontinuously controls the number of backup application agents on the computer network, it is possible to detect the number of backup application agents on the computer network.

The communication in relation to the detection of the backup application agents may be a ping transmitted by the backup managing means which the agents respond to.

When, as stated in claim 7, said backup managing means stores said data files in a common or individual database(s) in said backup system, an advantageous embodiment of the invention has been achieved.

It shall be emphasised that even though a backup system with at least two databases is advantageous, a system with only one database is possible e.g. a common database only.

The databases may physically be placed on one or more storage means e.g. one or more hard discs.

When, as stated in claim 8, said backup managing means performs a comparison between received data files and the data files stored in said backup system before storing the new files, it is possible to ensure that files e.g. with the same file name but with different file substances.

When, as stated in claim 9, said comparison involves the following methods: data file name comparison methods, data file size comparison methods, data file date comparison methods and/or methods of comparison on binary data file level, it is possible to reduce the number of stored files to the necessary minimum.

The files defining the computer settings are given the same name in several control systems or computer programs. If the files are solely compared on the basis of file names the result of the comparison will state that the files are identical. The system will only store one version of the files apparently being identical, and the users of the different computers (minus one) will hereby loose their private computer settings.

When, as stated in claim 10, storage of the data files is performed when one of said comparison methods indicates that the compared files are not identical, an advantageous embodiment of the invention has been achieved.

When, as stated in claim 11 different data files with the same data file name are stored with an extension indicating the originating computer as a result of the comparison, it is possible to keep files with identical file names separated in the same storage area.

In accordance with the invention, claim 12 states a parallel backup system comprising at least two computers (WS1, WS2, WS3) connected in a computer network (2), said computers including at least two backup application agents (BUA1, BUA2, BUA3), at least one backup server (BUS1, BUS2) including at least one database, backup managing means (8) capable of establishing data communication connections to said backup application agents (BUA1, BUA2, BUA3) and data connections to said at least one database, and said backup application agents (8) incorporating means for continuously or discontinuously transmitting or allowing transmission of data files of said computers in a parallel manner to said backup managing means (8) subsequent to establishment of said data communication connections, and said backup managing means (8) storing said data files in said at least one database.

By means of the parallel transmission of data files from the computers in the network, a faster backup may be performed. Especially, it is possible to perform continuous transmission of data files from the computers and, thus, enhance the safety of the computer system and avoid loss of data.

When, as stated in claim 13, each computer (WS1, WS2, WS3) comprises a backup application agent (BUA1, BUA2, BUA3), an advantageous embodiment of the invention has been achieved.

When, as stated in claim 14, said databases comprise a common database (CDB) and one or more individual databases (IDB), an advantageous embodiment of the invention has been achieved.

When, as stated in claim 15, the databases (CDB1, CDB2, IDB1, IDB2) are placed in another computer than that of the backup server (BUS1), it is possible to establish backup systems where the databases are placed in a different location and the transmission may be performed on an Internet connection.

In a further embodiment the system may be used to backup the computers of a local office and transmitting the data files to the data center at the company headquarter over an Internet connection.

When, as stated in claim 16, one or more of the databases (CDB1, CDB2, IDB1, IDB2) are duplicated to another computer besides the backup server (BUS1), it is possible to establish a high degree of backup safety as the server and the further computer may be located separately. By placing the databases at different locations the possibility of at least one of the backup databases surviving e.g. a fire is increased significantly.

When, as stated in claim 17, the system includes comparison means capable of performing a number of different comparisons between program and data files such as comparison of file names, file size, file date and binary entities of the files, it is possible to establish a clear indication regarding whether files are identical or not

When, as stated in claim 18, the control system and common program files are stored in the common database (CDB1, CDB2), it is possible to minimize the storage occupied by files since only one copy of identical files are stored.

When, as stated in claim 19, document files are stored in the individual database (IDB1, IDB2), it is possible for the administrator of the backup system to specify the storage placing of some or all data files. Especially, it is possible to store private and confidential files in the users individual database and hereby achieving a high degree of safety.

When, as stated in claim 20, the backup managing means (8) includes one or more data file extension filters, a user may only see or retrieve the files bearing his own extension. Hereby, files with different extensions may be positioned in the same storage area without having any data structure in the area, as the filters will only allow a user to see or retrieve his own files.

When, as stated in claim 21, the backup managing means (8) includes network bandwidth control means, it is possible to keep the response time in the computer network low as the backup managing means will only occupy a pre-established amount of the available capacity in computer network.

When, as stated in claim 22, the computer network (2) is a separate backup network, an advantageous embodiment of the invention has been achieved. Especially, in situations where a high number of computers are present on a computer network it may be advantageous to establish a separate network for backup operations only in order to keep the response time in the computer network low.

Further, in view of maintenance, installation and upgrading of the network components the separate network is advantageous.

When, as stated in claim 23, the backup managing means (8) is connected to the backup application agents (BUA1, BUA2, BUA3) with multiple connections such as port or lines (B1, B2, B3) allowing parallel data communication and transmission of data files, it is possible to perform the backup faster than normally.

When, as stated in claim 24, the backup managing means (8) includes processor means capable of multitasking data and data files continuously in a parallel mode, it is possible to get a faster backup.

When, as stated in claim 25, backup application agents incorporating means for continuously transmission of data files; it is possible to get a faster backup.

### DRAWINGS

The invention will be described in detail in the following with reference to the drawings of which

FIG. 1 shows a standard backup system,

FIG. 2 shows a preferred embodiment of a backup system according to the invention,

FIGS. 3a and 3b show the at least two databases, a common database and at least one individual database,

FIG. 4 shows a detailed view of parallel data file transmission,

FIG. 5 shows a further embodiment of the invention including two backup servers,

FIGS. 6a and 6b show a flow chart of the functionality of the invention during startup, and

FIGS. 7a and 7b show a flow chart of the functionality of the invention during standard operation.

### DETAILED DESCRIPTION

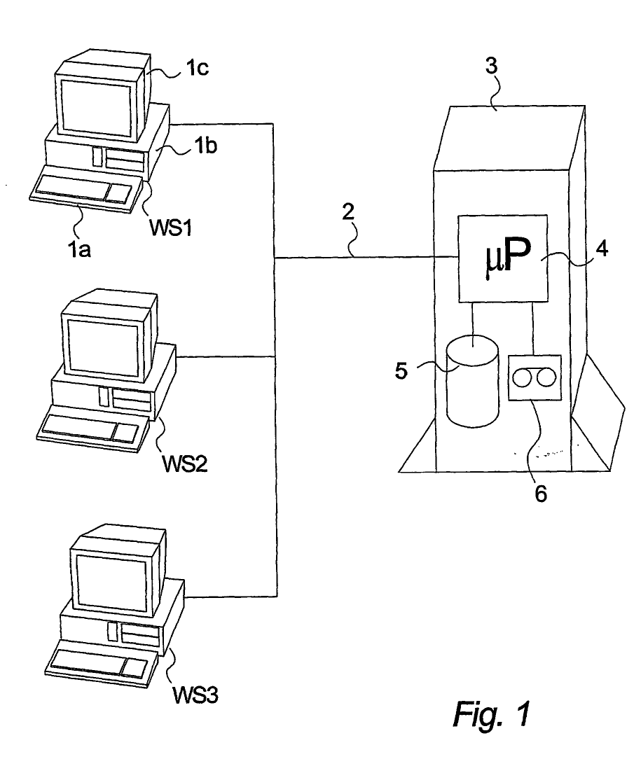

FIG. 1 shows a standard computer system in which several computer workstations, WS1, WS2, WS3, are connected through a computer network 2 to a network server 3 with microprocessor means 4 and a data storage medium 5.

Each individual computer WS1, WS2, WS3 is built up in the traditional manner with a central unit 1b which includes a processor, a storage medium and memory etc. In addition, the computers WS1, WS2, WS3 have a screen 1c and a computer input device 1a and the computer input device is shown as a keyboard. Usually, the keyboard would be accompanied by a computer mouse, a trackball, a computer pen or a similar computer input device.

Further, the central server 3 comprises a backup tape station 6 utilized to copy material from the data storage medium 5 to a computer tape on a daily basis in order to establish permanent storage. The storage mediums of the computers WS1, WS2, WS3 may also be successively stored on computer tape.

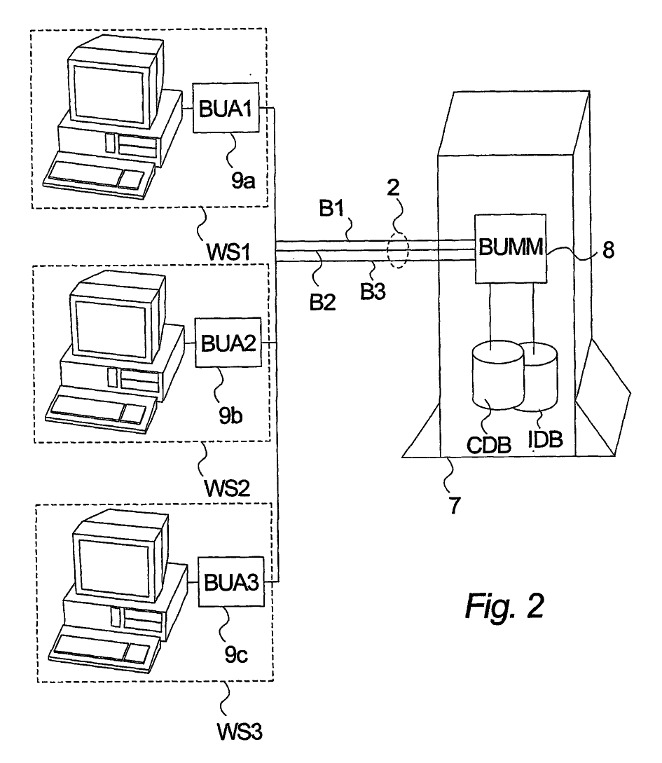

FIG. 2 shows a preferred embodiment of the invention. The embodiment includes a backup server 7 comprising backup managing means (BUMM) 8 and a number of databases CDB, IDB. The backup server may be a separate server or be incorporated in the central network server 3.

The network further comprises a number of computers WS1, WS2, WS3 each comprising a backup application agent BUA1, BUA2, BUA3.

The backup manage means sends out pings (requests) and the backup application agents respond allowing the backup manage means to know the number of backup application agents being present.

The backup managing means 8 continuously receives backup data and information packets on the network connections such as ports B1, B2, B3 from backup application agents, BUA1, BUA2, BUA3 and the agents mark the data and information from the respective computers which allows for identification of the data and information packets. The backup application agents may shadow the operations and processes of the computers.

The backup application agents, BUA1, BUA2, BUA3 and the backup managing means 8 connect in a continuous or discontinuous manner by means of which the backup managing means 8 detects the number of present backup application agents and initially receives information from the backup application agents regarding the computer and the control system used on the computer.

The detection of present backup application agents may be continuous (online) or discontinuous with the backup managing means 8 detecting the number of present backup application agents and thus the number of active computers on the network 2 every few seconds.

If the computer correctly is turned off or is made offline in relation to the network the backup process is stopped in a normal manner since the backup application agent will inform the backup managing means 8 that it is leaving the network. When the computer WS1, WS2, WS3 returns on the network the backup manage means 8 detects the presence of the backup application agent and starts receiving data files and information.

If the computer leaves the computer network in a incorrect manner, e.g. because of a power failure, the backup application agent will also leave without notifying the backup managing means 8 and it will not be able to ping the backup application agent. Hereby, the backup managing means 8 will know that the backup application agent and the computer might have crashed.

Further, the backup application agents continuously or discontinuously detect whether the backup managing means 8 and the backup server are working or not If the backup managing means 8 is not detected by the individual backup application agents, they may inform the users of the computers WS1, WS2, WS3 of the risk of a backup server crash

When the user performs an operation on his computer WS1, WS2, WS3, which involves any kind of change on the computer, the backup application agent detects the changes and transmits the changes over the network 2 to the backup managing means 8. The backup managing means 8 receives and evaluates these changes. On basis of the evaluation, the changes are stored in a database chosen from at least two databases.

The backup managing means does in a normal mode pings the backup agents. If the managing means stops pinging the agents, the agents will automatically reverse the process and becoming the pinging part.

The pinging frequency can be every 5 minutes. Hereby, security is kept high without overloading the backup application agents or the network in any way.

In a preferred embodiment of the invention the backup agent hands over the computing process to the backup managing means. The agent allows the data files to be transmitted and the managing means performs the transmission of the files. Hereby, a small CPU power consumption of the agent computer is achieved.

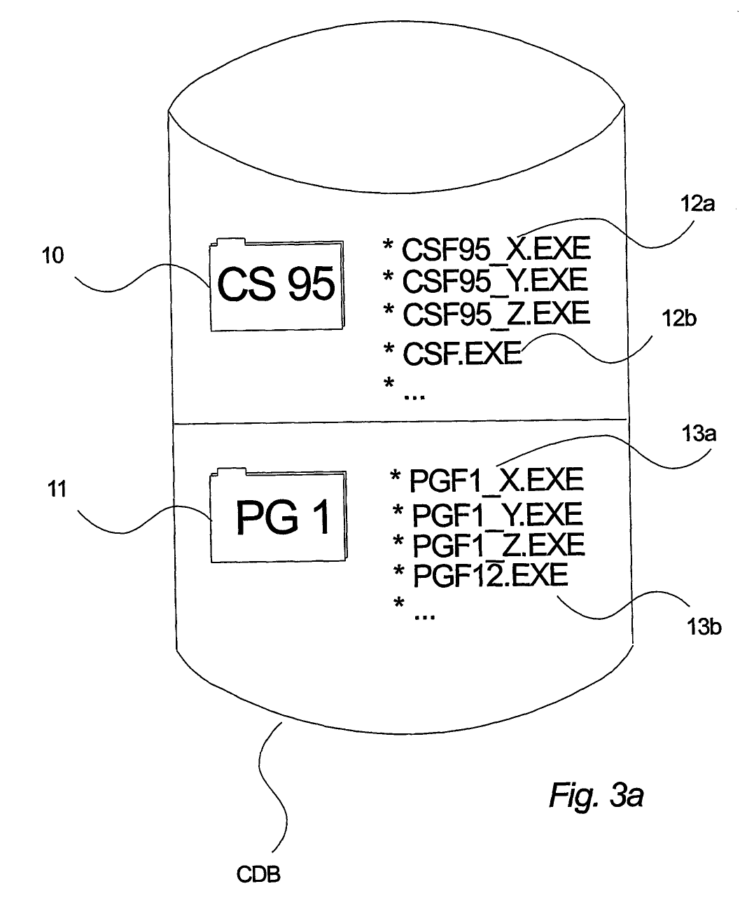

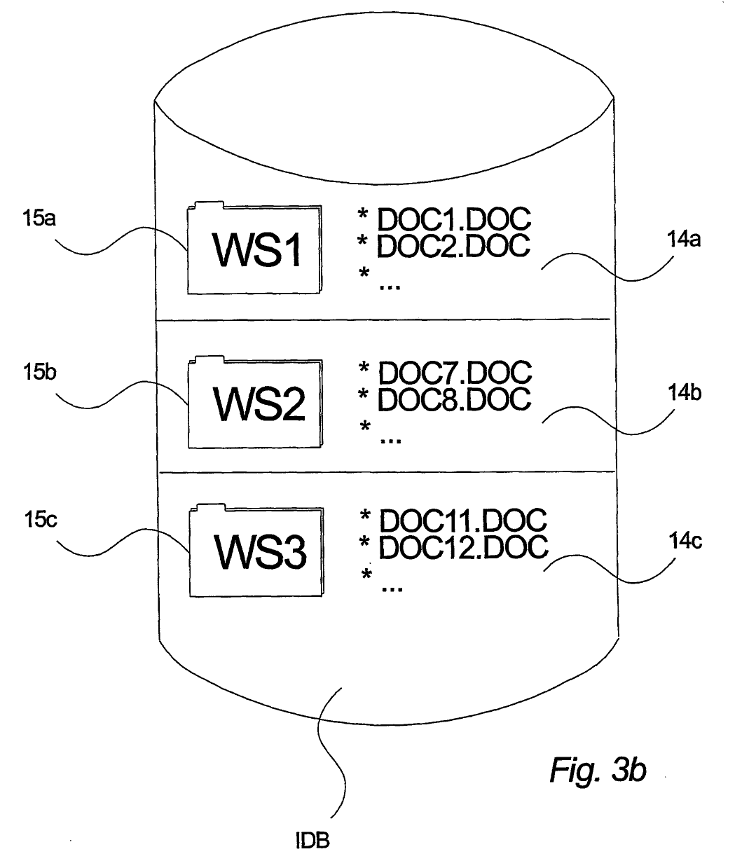

FIG. 3a and FIG. 3b show the at least two databases that are at least one common database CDB and at least one individual database IDB.

The common database CDB of FIG. 3a may comprise the backup of the control system files 10 and data program files 11 in directories.

The control system files are stored in a version of the occurring control systems e.g. in a Microsoft Windows environment: Windows 95, Windows 98, Windows 2000 and so forth.

The data program files may comprise any type of data program which is stored on one or more of the computers and not forming part of the control system, e.g. Microsoft Office data programs such as Word, Excel and Outlook or data programs involving functionalities such as drawing, database or multimedia

The backup versions of the control systems and the data programs will be placed in main directories. However, in the main directories, the separate control system or data program is placed with the same directorial structures as those of the computers.

If the backup managing means 8 receives information from a backup application agent that a new computer has locked on to the network 2, it scans the content of the computer hard disk.

In the event that the computer has a control system which has not been detected and stored before, the backup managing means 8 initially compares the control system with control systems in a reference database in order to verify that the control system is intact and functional After a complete comparison, the control system is stored in its own directory in the common database CDB.

During any kind of communication and file transfer in between the backup server and any computer in the network system a virus scan process is performed.

If the control system already exits in the common database CDB, the files are initially compared with the existing files and stored if found different. The comparison may include a number of different steps such as:

A) File name comparison and if a match, then

B) Size comparison and if a match, then

C) File date comparison and if a match, then

D) Binary comparison and if still a match, then no storage.

If A) shows a no-match, then the file is stored with its own file name 12b. If B), C) or D) show a no-match, then the file is stored with its own file name and a file name extension 12a indicating the computer of origin.

Further, attributes of the data files may also be compared.

In a further embodiment of the invention, the backup managing means 8 excludes different segments of data files on the computer hard disks such as not yet permanently deleted files (files in the wastebasket) and temporary files.

The administrator of the backup system of a computer can also manually exclude data files of his computer from backup storage by indicating to the backup managing means that the files are not relevant backup material. Further, the user or in particular the administrator may change the storage place e.g. a data program stored in an individual database instead of in the common database.

In a preferred embodiment, the user of the computer of origin may only see the files which belong to his own computer. This is established by using filters allowing the user to see files with no extension or the extension belonging to the user. Further, the user may only read or copy the files but not delete them.

The files of the individual database are also compared before storage as described in relation to the control system files.

The user of a computer may only see the section of the individual database belonging to his computer.

In a further embodiment of the invention, the backup managing means may store several versions of a data file e.g. the ten last versions of a data file. The ten versions may be stored with an extension such as a number indicating the status of the file.

In an even further embodiment of the invention, the backup managing means may control the bandwidth of the network allocated to the transmission of backup data files e.g. 10% of the total network bandwidth.

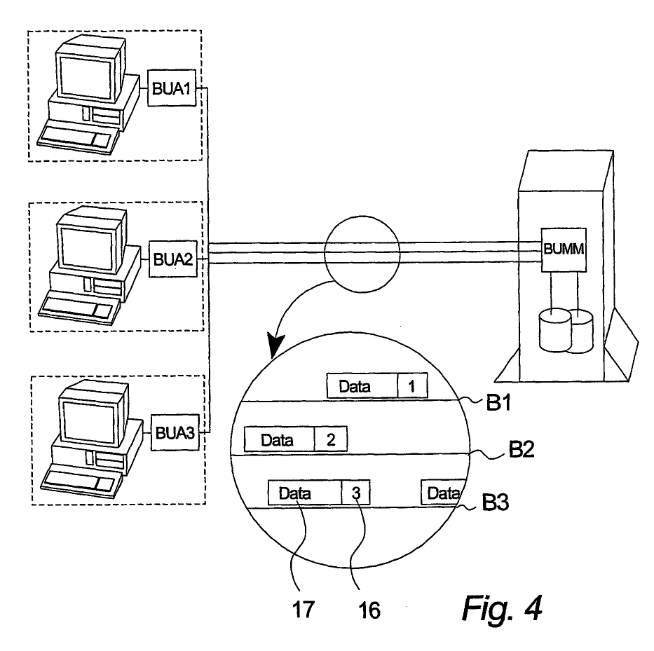

FIG. 4 shows a detailed view of the parallel and continuous transmission of backup data files. The data files are transmitted as data packets on the computer network in which several packets are transmitted concurrently and from different computers on a number of different network ports.

The packets comprise data files or parts of data files 16 and identification code 17 where the code is the mark of the individual backup application agents. The marking of the packets with the identification code is performed in order to allow the backup managing means 8 to identify the packets upon arrival.

The transmission of packets may be continuous which means that the backup application agent of the computer immediately detects changes in a data file on the computer WS1, WS2, WS3 and transmits the data file to the backup managing means 8.

In a preferred embodiment, the backup managing means 8 controls the bandwidth of the computer network 2 e.g. by defining a fixed maximum data level used by the backup system in relation to the total network capacity. Hereby, in situations in which significant amounts of data are to be transmitted for backup, the data files may be deferred in the network However, the transmission of packets from the individual computers is still continuous but the arrival at the backup managing means 8 may be more or less delayed if preferred by the computer network administrator.

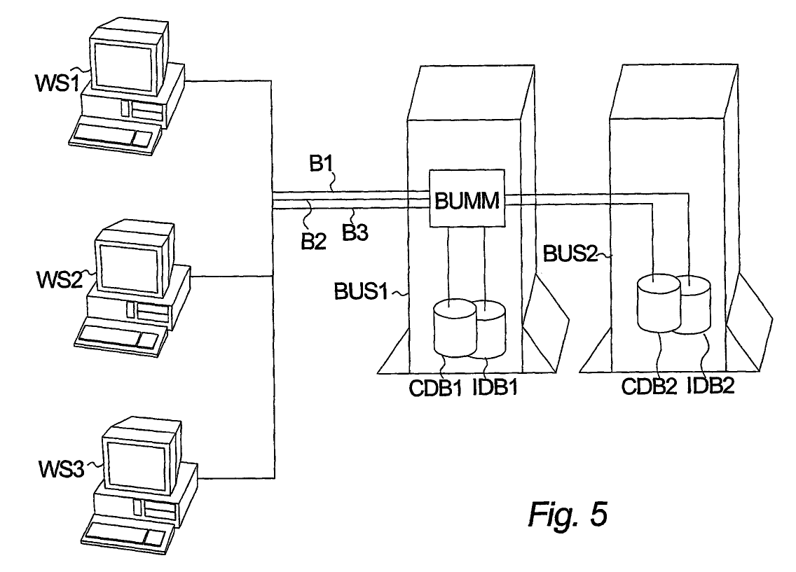

FIG. 5 shows another embodiment of the invention in which the databases of the backup server BUS1 are duplicated to another backup computer or computer server BUS2. In a further embodiment, the backup managing means 8 may be positioned on one server and the backup databases on another.

The database servers are preferably placed in different sections of a location in order to enhance the safety of the backup system. Further, the servers may be placed in different locations, such as different countries, and be connected by means of an Internet connection or other kind of communication systems.

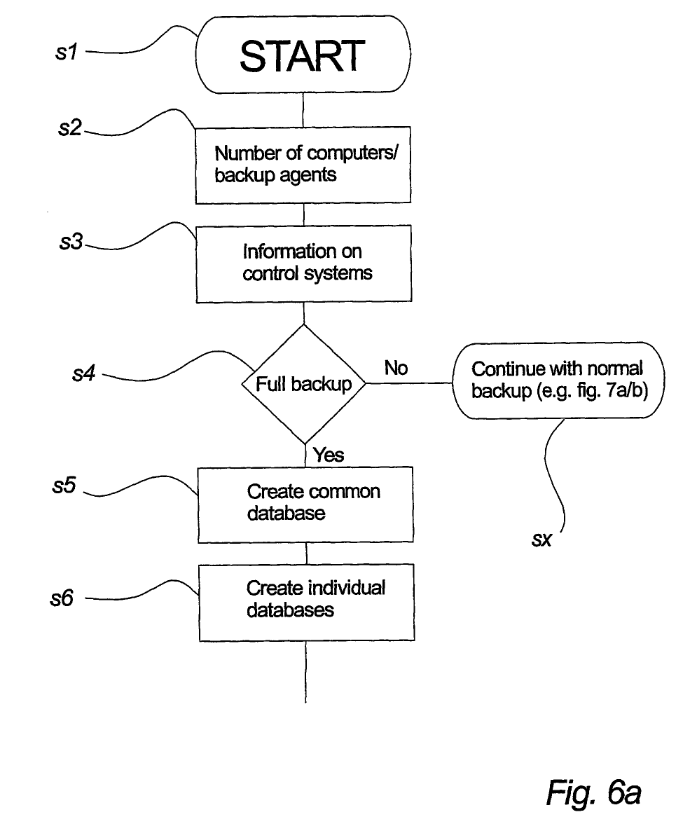

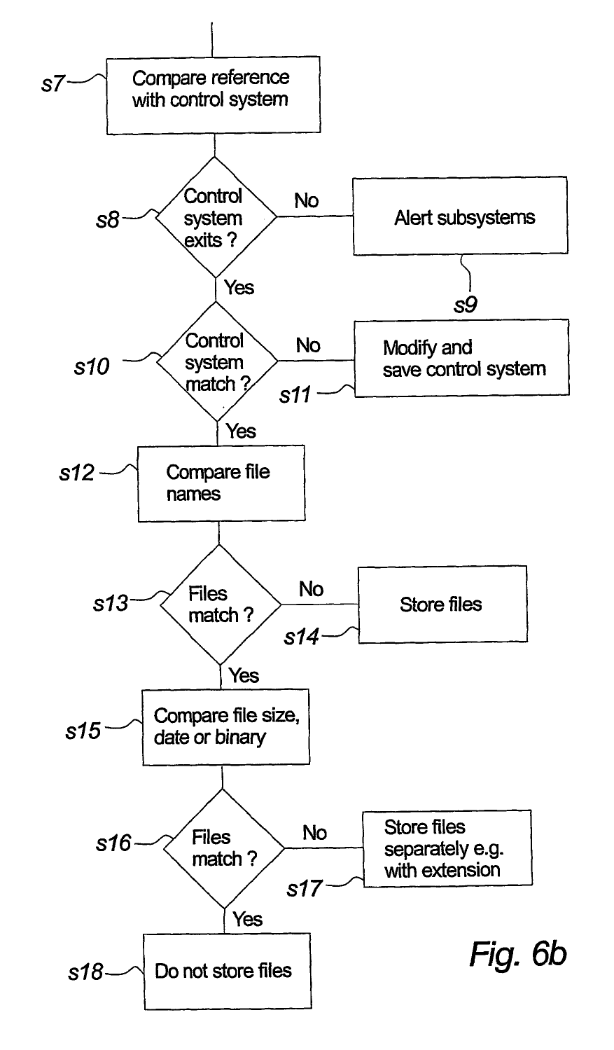

FIGS. 6a and 6b show a flow chart of the functionality of an embodiment of the invention at start-up in continuation of each other. The start-up situation involves a number of steps in order to establish the structure of the backup system.

The first step is that of detecting the number of backup application agents and thus computers in the computer network by means of the backup managing means (step s2). Further, the backup managing means receives information from the backup application agents regarding the control systems of the computers (step3).

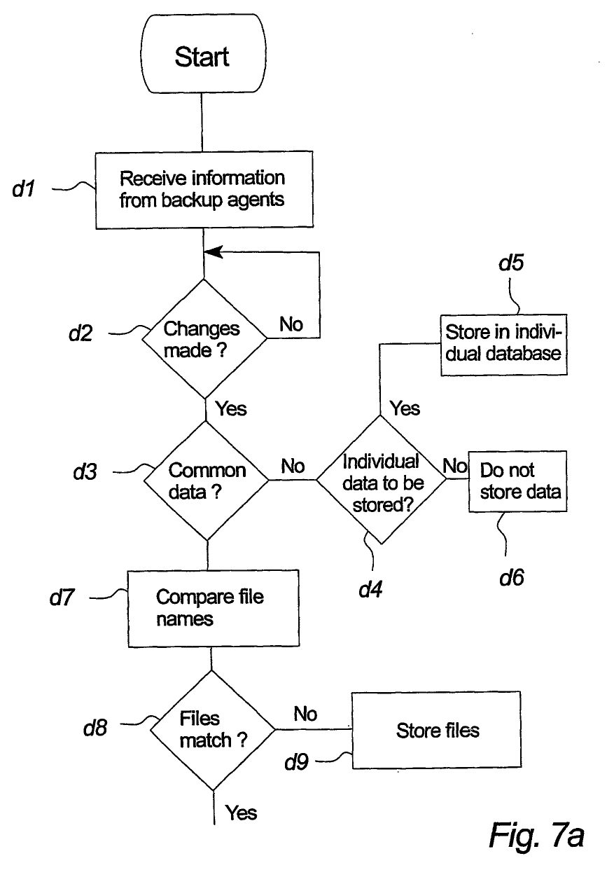

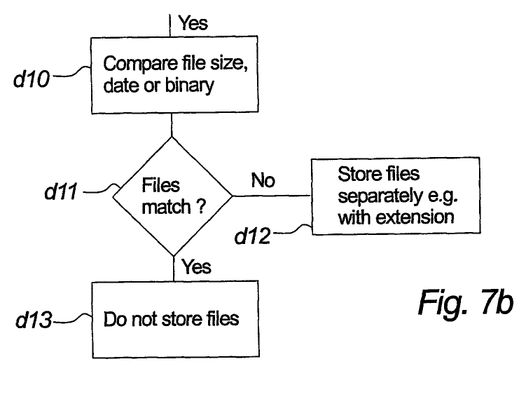

The first time the backup system is activated, a complete backup has to be performed on all files (or at least all valuable files) stored on the computers (step s4). On the other hand if the backup system already exists the backup may be performed as described in relation to FIGS. 7a and 7b (step sx).

In relation to the initial complete backup, the necessary databases have to be created, i.e. the at least one common database and the individual database. The databases each start with a main directory under which the stored files may be positioned (steps s5, s6).

After the creation of the databases, the control systems of the detected computers are compared with references of different control systems in order to secure that the control systems exist and match the references (steps s7, s8, s10).

If the match is less because a file is positioned incorrectly, the control system may be stored in the common database and the file be moved to the correct position (step s11). In a recovery situation the control system may be recovered in a manner ensuring that the file is positioned in its original (incorrect) position.

Otherwise, the control system with the incorrectly positioned file may be stored in the individual database without making any changes.

The first version of a control system may be stored without comparing the data files of the control system with other files in the common database. The versions to follow are compared in a number of comparisons (step s13, s15, s16) which may include a number of different steps such as:

A) File name comparison and if a match (step s13), then

B) Size comparison and if a match (step s15), then

C) File date comparison and if a match (step s15), then

D) Binary comparison (step s15) and if still a match, then no storage (step s18).

If A) shows a no-match, then the file is stored with its own file name (step s14). If B), C) or D) show a no-match, then the file is stored with its own file name and a file name extension indicating the computer of origin (step s17).

The same process is performed on program files to be stored in the common database.

After the start-up, the backup system holds a mirrored version of the data files and data structure of the respective computers.

FIGS. 7a and 7b show a flow chart of the functionality of an embodiment of the invention during normal use in continuation of each other. The normal use situation involves a number of steps in order to maintain effective storage of data files in the backup system.

The embodiment of FIG. 7a and FIG. 7b involves the following steps:

The backup managing means receives information such as data files or on/off-line information from the backup application agents (step d1), and if the information indicates that a change has been made, the backup managing means evaluates the changes (step d2).

If changes are indicated in the control system files or the program files, the files are compared in a number of comparisons (step d3, d7-d11) which may include a number of different steps such as:

A) File name comparison and if a match (step d7-d8), then

B) Size comparison and if a match (step d10-d11), then

C) File date comparison and if a match (step d10-d11), then

D) Binary comparison (step d10-d11) and if still a match, then no storage (step d13). Otherwise, the file is stored in the common database (step d9, d12).

If the change is in a document file (step d4-d6), the file is stored in the individual database belonging to the computer in question and in a place mirroring the storage place on the computer. The individual database is also used if the administrator has specified that the data file should be stored in the individual database.

If the user of a computer turns off his computer, the backup managing means will update the list of present backup application agents as the one belonging to the computer is no longer present and backup therefore no longer relevant. In a preferred embodiment the backup application agents inform the backup managing means when they leave the computer network.

The number of computers on the normal computer network may reach such a high number that it is relevant to create a separate backup network which operates partly or totally independent of the normal network.

In an even further embodiment of the invention a physical distributable computer program product of the present backup system and method is stored on a computer-readable storage medium, comprising computer readable program code. The computer-readable storage medium may be any kind of medium used within the area e.g. DVD-ROMs, CD-ROMs, computer diskettes, RAM discs, hard discs etc.

The backup system may in a preferred embodiment be used in a client-server environment.

Modifications of a method and backup system according to the invention may be made without departing from the scope of the invention, which is defined in the accompanying claims.

### List

1a. Computer input device

1b. Central unit

1c. Computer screen

2. Computer network

3. Network server

4. Microprocessor

5. Data storage medium

6. Tape station

7. Backup server

8. Backup managing means

9a, 9b, 9c. Backup application agent

10. Directory of control system files

11. Directory of data program files

12a, 12b. Control system files with and without extensions

13a, 13b. Data program files with and without extensions

14a, 14b, 14c. Document files

15a, 15b, 15c. Directories for document files

16. Identification code

17. Data files

B1, B2, B3. Multiple line

BUA1-BUA3. Backup applicant agents

BUMM Backup managing means

BUS1, BUS2. Backup servers

CDB. Common database

D1-Dx. Step 1 to x

IDB. Individual database

S1-Sx. Step 1 to x

WS1-WS3. Workstations/computers

1. Method of parallel transmission of data files from computers in a computer network and storage of said data files in a backup system connected to said network, said method comprising the steps of
establishing parallel data communicating connections between at least two backup application agents of at least two computers and the backup managing means of said backup system,
parallel transmission or allowing transmission of data files from at least one computer with identification codes from said at least one backup application agent to said backup managing means, and
storage of said data files in one or more databases of said backup system.

2. Method according to claim 1, whereby said backup application agents continuously monitor the activity of the computers and transmit data files to said backup managing means.

3. Method according to claim 1 or 2, whereby said transmitted data files are transmitted as compressed data packets.

4. Method according to any of the claims 1 to 3, whereby said backup application agents continuously or discontinuously control the status of the backup managing means.

5. Method according to claim 4, whereby said backup application agents report the offline status of the backup managing means to the users of the computers e.g. by means of a pop-up message on the screens of the computers.

6. Method according to any of the claims 1 to 5, whereby said backup managing means continuously or discontinuously monitors the number of backup application agents in the computer network by parallel communicating with the backup application agents e.g. by pinging the backup application agents.

7. Method according to any of the claims 1 to 6, whereby said backup managing means stores said data files in a common or individual database(s) in said backup system.

8. Method according to any of the claims 1 to 7, whereby said backup managing means performs a comparison between received data files and the data files stored in said backup system before storing the new files.

9. Method according to claim 8, whereby said comparison involves the following methods: data file name comparison methods, data file size comparison methods, data file date comparison methods, data file attributes and/or methods of comparison on a binary data file level.

10. Method according to claim 9, whereby storage of the data files is performed when one of said comparison methods indicates that the compared files are not identical.

11. Method according to any of the claims 8 to 10, whereby different data files with the same data file name are stored with an extension indicating the originating computer as a result of the comparison.

12. Parallel backup system comprising
at least two computers (WS1, WS2, WS3) connected in a computer network (2), said computers including at least two backup application agents (BUA1, BUA2, BUA3),
at least one backup server (BUS1, BUS2) including
at least one database,
backup managing means (8) capable of establishing data communication connections to said backup application agents (BUA1, BUA2, BUA3) and data connections to said at least one database, and
said backup application agents (8) incorporating means for continuously or discontinuously transmitting or allowing transmission of data files of said computers in a parallel manner to said backup managing means (8) subsequent to establishment of said data communication connections, and
said backup managing means (8) storing said data files in said at least one database.

13. Parallel backup system according to claim 12, wherein each computer (WS1, WS2, WS3) comprises a backup application agent (BUA1, BUA2, BUA3).

14. Parallel backup system according to claim 12 or 13, wherein said databases comprise a common database (CDB) and one or more individual databases (IDB).

15. Parallel backup system according to any of the claims 12 to 14, wherein the databases (CDB1, CDB2, IDB1, IDB2) are placed in another computer than that of the backup server (BUS1).

16. Parallel backup system according to any of the claims 12 to 15, wherein one or more of the databases (CDB1, CDB2, IDB1, IDB2) are duplicated to another computer besides the backup server (BUS1).

17. Parallel backup system according to any of the claims 12 to 16, wherein the system includes comparison means capable of performing a number of different comparisons between program and data files such as comparison of file names, file size, file date, data file attributes and binary entities of the files.

18. Parallel backup system according to any of the claims 12 to 17, wherein the control system and common program files are stored in the common database (CDB1, CDB2).

19. Parallel backup system according to any of the claims 12 to 18, wherein document files are stored in the individual database (IDB1, IDB2).

20. Parallel backup system according to any of the claims 12 to 19, wherein the backup managing means (8) includes one or more data file extension filters.

21. Parallel backup system according to any of the claims 12 to 20, wherein the backup managing means (8) includes network bandwidth control means.

22. Parallel backup system according to any of the claims 12 to 21, wherein the computer network (2) is a separate backup network.

23. Parallel backup system according to any of the claims 12 to 22, wherein the backup managing means (8) is connected to the backup application agents (BUA1, BUA2, BUA3) with multiple ports (B1, B2, B3) allowing parallel data communication and transmission of data files.

24. Parallel backup system according to any of the claims 12 to 23, wherein the backup managing means (8) includes processor means capable of multitasking data and data files continuously in a parallel mode.

25. Parallel backup system according to any of the claims 12 to 24, wherein backup application agents (8) incorporating means for continuously transmission of data files.

26. Computer program product stored on a computer-readable storage medium, comprising computer readable program code:
method of parallel transmission of data files from computers in a computer network and storage of said data files in a backup system connected to said network, said method comprising the steps of
establishing connections between at least two backup application agents of at least two computers and the backup managing means of said backup system,
parallel transmission of data files from at least one computer with identification codes from said at least one backup application agent to said backup managing means, and
storage of said data files in one or more databases of said backup system.

27. Use of a method of parallel transmission of data files from computers in a computer network and storage of said data files in a backup system according to any of the claims 1 to 11, a parallel backup system according to any of the claims 12 to 25 and a computer program product according to claim 26 in a client-server environment.
